(19) United States
(12) Patent Application Publication
(10) Pub. No.: US 2026/0290019 A1
(43) Pub. Date: Sep. 24, 2026

(54) METHOD OF SCENE CHANGE DETECTION IN MONITORING SYSTEM

(71) Applicant: CUPOLA360 INC., HSINCHU CITY (TW)

(72) Inventors: Yi-Ling WU, Hsinchu City (TW); CHUNG-YEN LU, Hsinchu City (TW)

(21) Appl. No.: 19/088,419

(22) Filed: Mar. 24, 2025

(51) Int. Cl. G06V 20/52; G06T 7/11; G06V 10/88; G06V 20/70

(52) U.S. Cl. CPC G06V 20/52; G06T 7/11; G06V 10/88; G06V 20/70

(57) ABSTRACT

A method of scene change detection applicable to a monitoring system having an image capture module is disclosed. The method comprises steps of: capturing a first image and a second image, each containing a same target by the image capture module at different timestamps; respectively transforming the first and the second images into a first semantic segmentation mask and a second semantic segmentation mask using a trained semantic segmentation model; comparing class values of a first resultant map and a second resultant map derived from the first and the second semantic segmentation masks on a pixel-by-pixel basis to count a number P1 of pixel positions with different class values; and, triggering one or more actions by the monitoring system according to P1 and a size of the first and the second resultant maps.

### BACKGROUND OF THE INVENTION

### Field of the Invention

The invention relates to image processing, and more particularly, to a method of scene change detection (SCD) in monitoring systems.

### Description of the Related Art

Scene change detection (SCD) plays a vital role in enhancing the efficiency and effectiveness of both security surveillance and environmental monitoring systems. Its importance stems from its ability to automatically identify significant changes in a monitored scene, reducing reliance on constant human observation and enabling faster responses to critical events. In security surveillance systems, SCD is invaluable for several reasons. Firstly, it significantly reduces the workload on human operators. SCD algorithms can automatically flag areas of interest, allowing security personnel to focus their attention on verified events rather than checking irrelevant data. This translates to quicker response times to incidents. Secondly, SCD improves the accuracy of surveillance. Human monitors can miss subtle but significant changes, leading to delayed responses or missed incidents entirely. Automated SCD systems provide a more objective and consistent analysis. For environmental monitoring systems, the importance of SCD is equally profound. Environmental changes, such as deforestation, pollution spills, or glacial retreat, often occur gradually and can be easily missed without regular, close monitoring. SCD provides a continuous, automated way to track these changes over time. By comparing current imagery with historical data, SCD algorithms can pinpoint areas where significant changes have occurred. This allows environmental scientists to respond more quickly to environmental threats, implement mitigation strategies, and track the effectiveness of conservation efforts. The automation provided by SCD is crucial for efficiently monitoring vast and remote areas where continuous human observation is impractical. Furthermore, the data collected by SCD systems provide valuable long-term records of environmental change, contributing to a better understanding of ecological processes and informing policy decisions.

However, in both security surveillance and environmental monitoring systems, SCD faces several technical challenges, including: (1) diversity of environmental changes: the monitored environment can be significantly affected by factors such as lighting, weather, seasons, and time of day, making it more difficult to detect changes in the scene; (2) background noise: in real-world applications, there may be many dynamic objects (such as pedestrians and vehicles) in the background that can interfere with the detection of scene changes, leading to false positives or missed detections; (3) algorithm accuracy: current SCD algorithms may perform inconsistently under different conditions, particularly in complex scenes where it can be challenging to accurately distinguish genuine changes from normal environmental fluctuations. For example, traditionally, a “background subtraction” technique used to calculate pixel value differences between a background image and a target image and also a threshold is set. When the amount of pixel value differences exceeds the threshold, it is determined that there is a scene change. However, the “background subtraction” technique is easily misled by changes in lighting and shadows, leading to false judgments regarding changes in scene objects.

Accordingly, what is needed is a new SCD scheme to improve safety, efficiency and accuracy in security surveillance systems and environmental monitoring systems. The invention addresses such a need.

### SUMMARY OF THE INVENTION

In view of the above-mentioned problems, an object of the invention is to provide a method of scene change detection, to improve safety, efficiency and accuracy in security surveillance systems and environmental monitoring systems.

One embodiment of the invention provides a method of scene change detection applicable to a monitoring system having an image capture module is disclosed. The method comprises steps of: capturing a first image and a second image by the image capture module at different timestamps, wherein each of the first and the second images contains a same target; respectively transforming the first and the second images into a first semantic segmentation mask and a second semantic segmentation mask using a pre-trained semantic segmentation model; comparing pixel values of a first resultant map and a second resultant map respectively derived from the first and the second semantic segmentation masks on a pixel-by-pixel basis to count a number P1 of pixel positions with different class values; and, triggering one or more actions by the monitoring system according to the number P1 and a total number of pixels in each of the first and the second resultant maps. Here, the first and the second resultant maps may be the reference and the current semantic segmentation masks in FIG. 2A, the reference and the current ROI label maps in FIGS. 3A and 3G, the reference and the current filtered maps in FIG. 4B, the reference and the current label maps in FIG. 5B, or the reference and the current relabel maps in FIG. 6B.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic diagram showing a security surveillance system 100 according to an embodiment of this invention.

FIG. 2A is a flow chart showing a method of scene change detection in the security surveillance system 100 according to this invention.

FIG. 2B shows a reference image containing a closed front door of a house.

FIG. 2C shows an exemplary reference label map corresponding to the reference image in FIG. 2B.

FIG. 2D shows a current image containing the front door in open status with an intruder having entered the house.

FIG. 2E shows an exemplary current label map corresponding to the current image in FIG. 2D.

FIG. 2F shows an example of a reference label map and a current label map having the same size of W0×H0.

FIG. 3A is a flow chart showing a method of scene change detection in the security surveillance system 100 according to an embodiment of this invention.

FIG. 3B shows an example of a reference ROI image based on the reference image in FIG. 2B.

FIG. 3C shows a reference ROI label map corresponding to the reference ROI image in FIG. 3B.

FIG. 3D shows an example of a current ROI image based on the current image in FIG. 2D.

FIG. 3E shows a current ROI label map corresponding to the current ROI image in FIG. 3D.

FIGS. 3F-3G depict a flow chart showing a method of scene change detection in the security surveillance system 100 according to an alternative embodiment of this invention.

FIGS. 4A-4B depict a flow chart showing a method of scene change detection in the security surveillance system 100 according to an alternative embodiment of this invention.

FIG. 4C shows an example of a portion of the reference relabel map and a corresponding portion of the reference filtered map.

FIGS. 5A-5B depict a flow chart showing a method of scene change detection in the security surveillance system 100 according to an alternative embodiment of this invention.

FIGS. 6A-6B depict a flow chart showing a method of scene change detection in the security surveillance system 100 according to an alternative embodiment of this invention.

FIGS. 6C-6F show four examples of how to obtain a majority element using m-adjacency Boyer-Moore Majority Voting algorithm.

FIG. 7 is a schematic diagram showing a security surveillance system 100T in a training phase according to an embodiment of this invention.

### DETAILED DESCRIPTION OF THE INVENTION

As used herein and in the claims, the term “and/or” includes any and all combinations of one or more of the associated listed items. The use of the terms “a” and “an” and “the” and similar referents in the context of describing the invention are to be construed to cover both the singular and the plural, unless otherwise indicated herein or clearly contradicted by context. Throughout the specification, the same components with the same function are designated with the same reference numerals.

A feature of the invention is to identify object information in a current image and a reference image based on AI image segmentation, calculate class value differences according to the results of AI image segmentation, and then determine whether the scene has changed according to the class value differences. The AI image segmentation is a pixel-wise object detection model trained on object information under varying lighting/shadow conditions, enabling effective object recognition. Another feature of the invention is to combine different algorithms to determine the distribution and the amounts of multiple classes for monitored scenes, thus improving misjudgments caused by weather or human-induced lighting changes.

Through the specification and claims, the following notations/terms take the meanings explicitly associated herein, unless the context clearly dictates otherwise. The term “scene change” should be interpreted as a change of status for a specified object/space (or a monitored scene) in this invention. For example, a door transitions from closed status to open status; a lawn transitions from status of only containing grass to status of being obscured by an intruder; a parking space transitions from occupied status to empty status; a painting that was hanging in a museum has gone missing; a forest's extent shrinks from a large area to a smaller one; a slope of a hillside land changes from a first angle to a second angle; an ocean surface transitions from clean and clear status to oil-slicked status; a volcano transitions from quiescence to intense gas emissions, and then to surrounding ground deformation, representing precursory signs of an eruption. The term “semantic segmentation (SS)” is a type of image segmentation that aims to assign a specific class label to each pixel in an image; in simpler terms, it's about understanding what is in an image at the pixel level. Common models for semantic segmentation include Fully Convolutional Networks (FCNs), U-Net, and DeepLab. The outputs of SS models typically include the following formats: pixel-wise label maps, and pixel-wise probability maps. The pixel-wise label map (hereinafter called “label map”) refers to a two-dimensional array of the same dimensions as the input image, where each element represents a pixel and its value is an integer corresponding to a specific class label. The pixel-wise probability map (hereinafter called “probability map”) refers to a multi-channel array where each channel represents a class, and the value of each pixel in a channel represents the probability that the pixel belongs to that class. The choice of format often depends on downstream processing or the specific needs of the application.

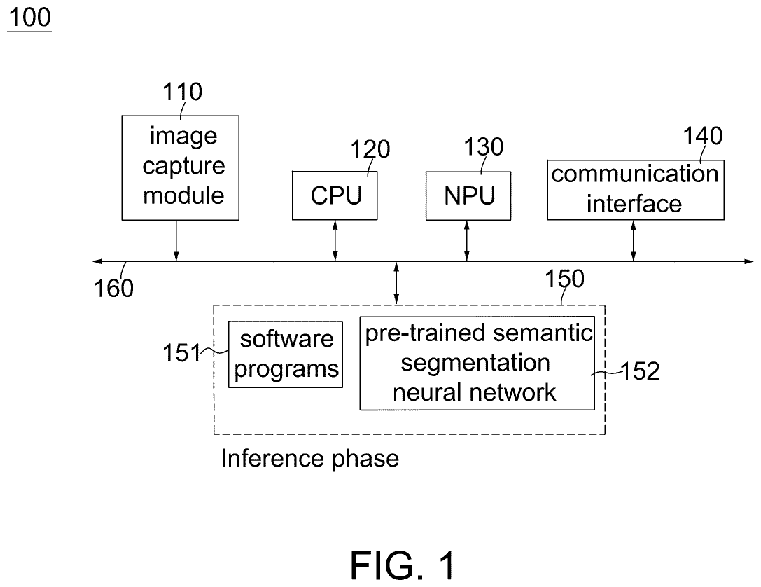

In practical applications, the results of SCD are most commonly applied in security surveillance systems and environmental monitoring systems. For purposes of clarity and ease of description, the following embodiments are described with reference to security surveillance systems; however, the principles presented in FIGS. 1-7 are fully applicable to environmental monitoring systems as well.

FIG. 1 is a schematic diagram showing a security surveillance system 100 according to an embodiment of this invention. Referring to FIG. 1, the security surveillance system 100 includes an image capture module 110, a CPU 120, a neural processing unit (NPU)130, a communication interface 140, and a storage device 150. The image capture module 110 may be a single-lens or multiple-lens camera, and configured to capture an image and store it in the storage device 150. The image capture module 110, the CPU 120, the NPU130, the communication interface 140, and the storage device 150 may communicate with each other through a system bus 160. The communication interface 140 may include a radio transceiver, wireless network communication transceiver, ad hoc wireless network communication transceiver, geospatial positioning system (GPS) device, some combination thereof, or the like.

The storage device 150 can include one or more non-transitory computer-readable storage mediums, such as RAM, ROM, EEPROM, EPROM, flash memory devices, magnetic disks, etc., and combinations thereof. The storage device 150 may store data and instructions/program codes of software programs 151 operable to be executed by the CPU 120 and the NPU 130 to cause the security surveillance system 100 to perform operations. For example, the storage device 150 may store variables such as signals, weights, and biases of a pre-trained semantic segmentation neural network 152 or may store parameters of neurons of the trained segmentation neural network 152. The CPU 120 may control or perform an overall operation of the security surveillance system 100, and may directly perform a certain operation in response to image data from the image capture module 110 or may instruct the NPU130 to perform operations based on the pre-trained SS neural network 152. The pre-trained SS neural network 152 is configured to receive an input image and output a SS mask (e.g., a label map or a probability map).

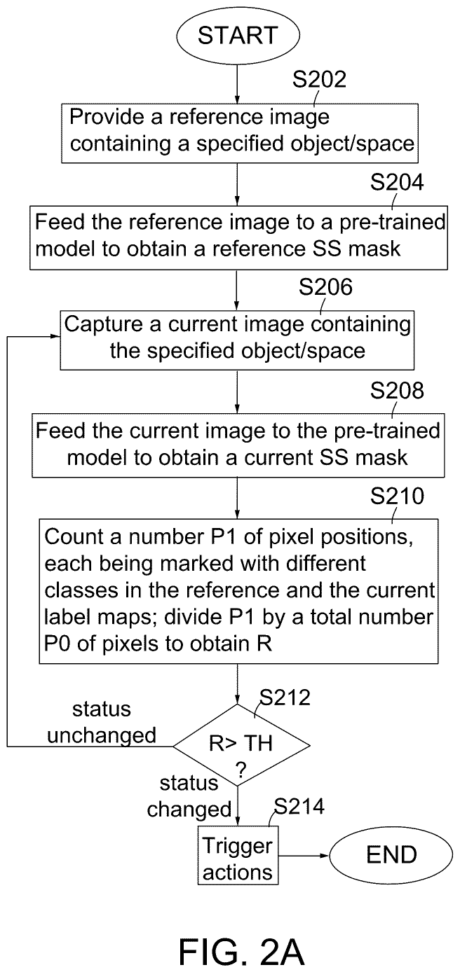

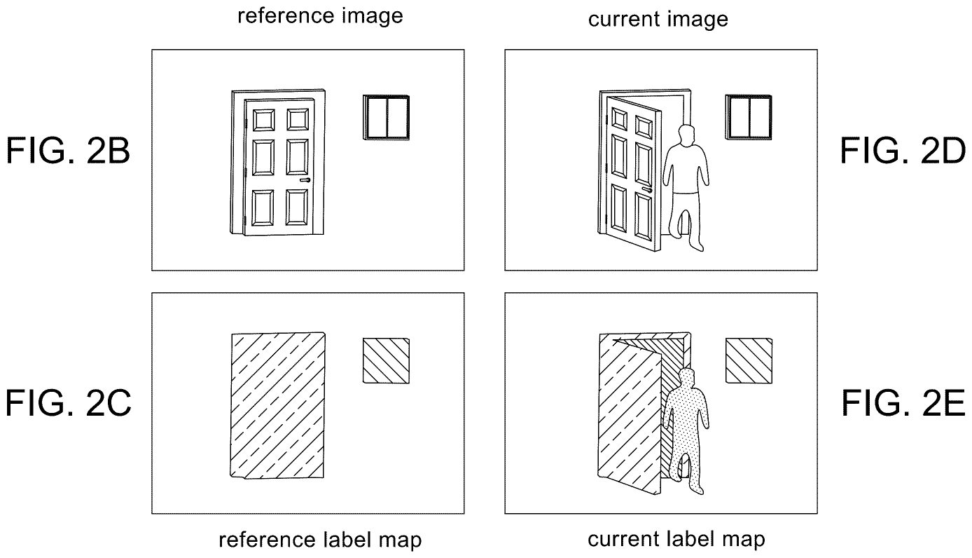

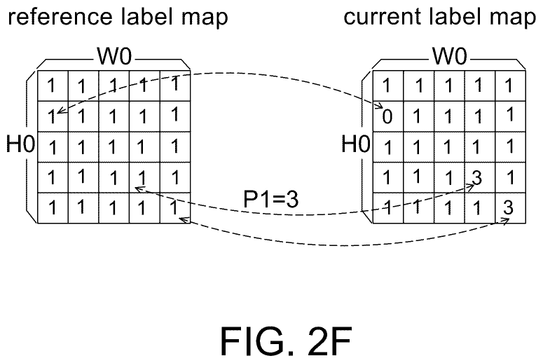

The storage device 150 stores multiple instructions of software programs 151 and multiple parameters of the pre-trained SS neural network 152 to be executed by the CPU 120 and the NPU 130 to perform all the steps of the methods of FIGS. 2A, 3A, 3F-3G, 4A-4B, 5A-5B and 6A-6B, as will be described in greater detail below. FIG. 2A is a flow chart showing a method of scene change detection in the security surveillance system 100 according to this invention. Hereinafter, the method of scene change detection of this invention will be described in detail with reference to FIGS. 1 and 2A.

Step S202: Provide a reference image containing a specified object/space (or a monitored scene) (such as a front door of a house, a lawn of a backyard, a parking space in a front yard, a painting in a museum, or the like) by the image capture module 110. It is assumed that the specified object/space is a closed front door of a house (as shown in FIG. 2B) in the following embodiments.

Step S204: Feed the reference image to a pre-trained model (i.e., the pre-trained SS neural network) 152 to output a reference SS mask, such as a reference label map or a reference probability map. If the reference SS mask is a probability map, then obtain a reference label map according to the reference SS mask. FIG. 2C shows an exemplary reference label map corresponding to an exemplary reference image in FIG. 2B. The reference label map in FIG. 2C shows two different patterns representing two different classes.

In an embodiment, the pre-trained model 152 is based on, as described by E. Xie, W. Wang, Z. Yu, A. Anandkumar, J. M. Alvarez, and P. Luo in Segformer: Simple and Efficient Design for Semantic Segmentation with Transformers, arXiv:2105.15203 (2021). In an alternative embodiment, the pre-trained SS neural network 152 is based on PP-MobileSeg, as described by S. Tang, T. Sun, J. Peng, G. Chen, Y. Hao, M. Lin, Z. Xiao, J. You and Y. Liu in PP-MobileSeg: Explore the Fast and Accurate Semantic Segmentation Model on Mobile Devices, arXiv:2304.05152 (2023). It should be understood, however, that the invention is not limited to these particular ready-made pre-trained SS models described above, but fully extensible to any existing or yet-to-be developed SS pre-trained models.

Step S206: Capture a current image containing the specified object or space (such as the front door) by the image capture module 110 and store the current image in the storage device 150. For example, FIG. 2D shows a current image containing the front door in open status with an intruder having entered the house.

Step S208: Feed the current image to the pre-trained model (i.e., the pre-trained SS neural network) 152 to output a current SS mask, such as a current label map or a current probability map. If the current SS mask is a probability map, then obtain a current label map according to the current SS mask. FIG. 2E shows an exemplary current label map corresponding to an exemplary current image in FIG. 2D. The current label map in FIG. 2E shows four different patterns representing four different classes.

Step S210: Count a number P1 of pixel positions, each of which is marked with different class values in the reference and the current label maps, and then divide P1 by a total number P0 (=H0*W0) of pixels to obtain R=P1/P0, where the size (or a total number of pixels) in each of the reference image, the current image, the reference label map and the current label map is equal to H0*W0. FIG. 2F shows an example of a reference label map and a current label map having the same size of W0×H0 pixels. Referring to FIG. 2F, H0=W0=5, so P0=25; there are a total number of three pixel positions (P1=3), each of which is marked with different class values in the reference and the current label maps (or a corresponding pixel position in the two label maps have different pixel values); so R= 3/25.

Step S212: Determine whether R is greater than a threshold value TH. If YES, it indicates the status of the specified object/space is changed and the flow goes to the step S214; otherwise, the flow returns to the step S206. For example, comparing FIGS. 2B and 2D, the front door, previously fully closed (the reference image), was found ajar, with an intruder having entered the house (the current image). In this scenario, the new status of the front door (or the scene change) would be detected because of R>TH and then it is determined that the house is at risk.

Step S214: Trigger one or more actions by the CPU 120. Triggering the one or more actions includes, without limitations, triggering alarms, notifying authorities, or even automatically deploying countermeasures based on the detected scene change. In an embodiment, upon determining that the house is at risk, the CPU 120 may proceed with sending of alert messages via the communication interface 140 to a cell phone (or equivalent devices) of a specified person (such as a security guard, an owner of the house or the police), and activation of warning audio signals via a speaker (not shown). The warning audio signals may cause an intruder/thief to stop the theft and/or run away.

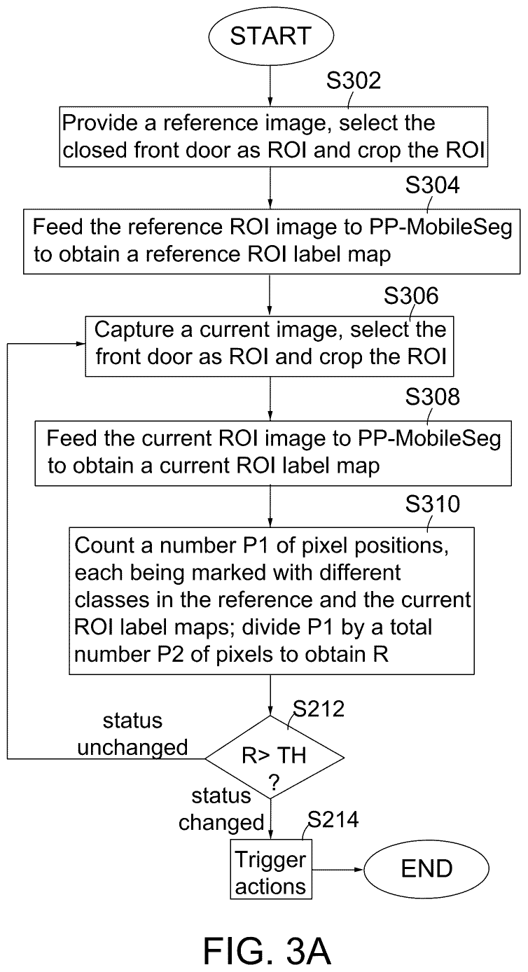

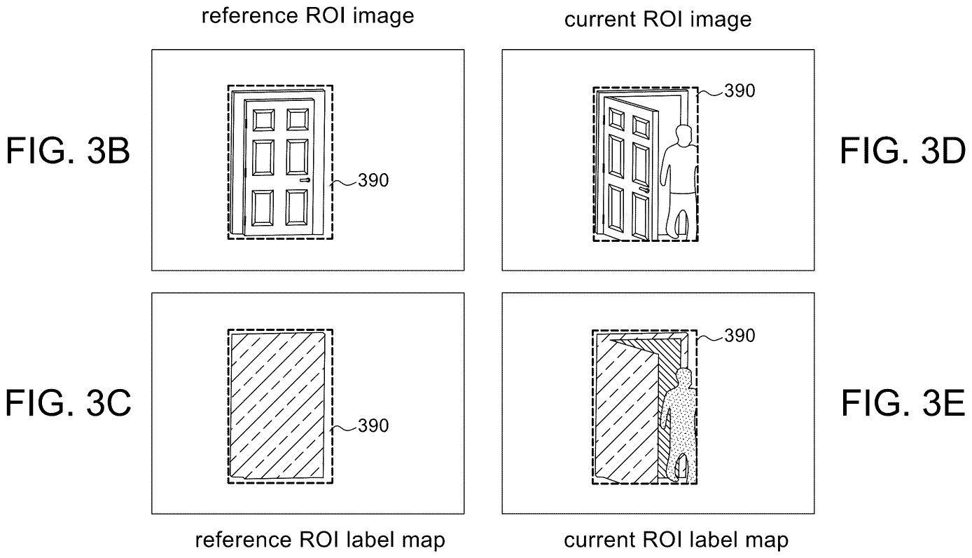

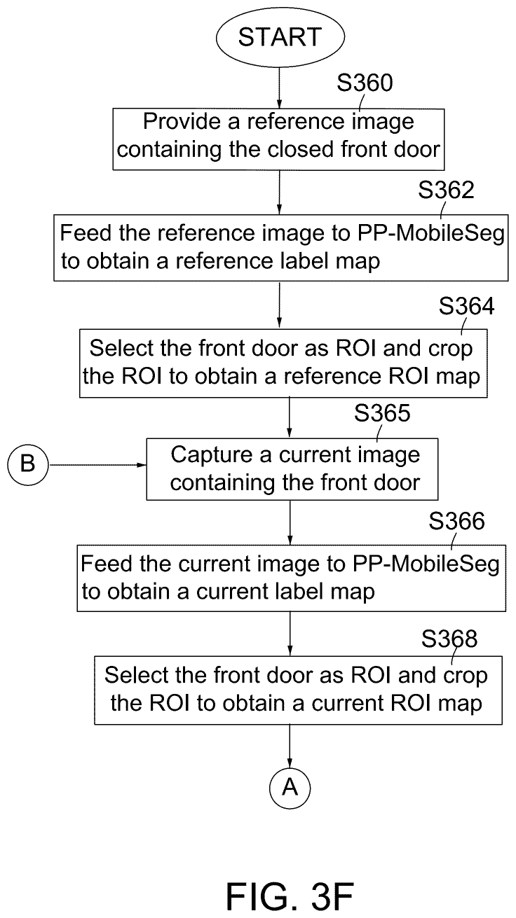

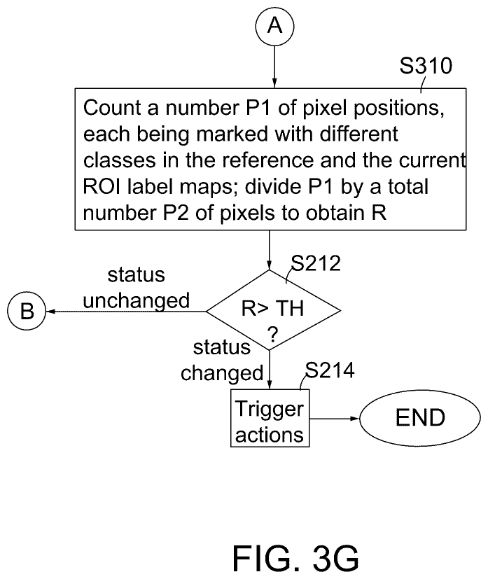

FIG. 3A is a flow chart showing a method of scene change detection in the security surveillance system 100 according to an embodiment of this invention. Hereinafter, the method of scene change detection of this invention will be described in detail with reference to FIGS. 1 and 3A. It is assumed that the pre-trained model 152 is PP-MobileSeg in FIGS. 3A, 3F-3G, 4A-4B and 5A-5B. It should be noted that the same functional blocks are designated with the same reference numerals in all the embodiments/flow charts.

Step S302: Provide a reference image containing the closed front door of the house (by the image capture module 110), select the front door as a region of interest (ROI) in the reference image, and crop the ROI out of the reference image to obtain a reference ROI image. For example, a reference ROI image is shown in FIG. 3B after an ROI 390 is selected and cropped out of the reference image in FIG. 2B.

Step S304: Feed the reference ROI image to the PP-MobileSeg model to output a reference ROI label map. The reference ROI label map is shown in FIG. 3C based on the reference ROI image in FIG. 3B.

Step S306: Capture a current image containing the front door (by the image capture module 110), select the front door as a ROI in the current image, and crop the ROI out of the current image to obtain a current ROI image. For example, a current ROI image is shown in FIG. 3D after the ROI 390 is selected and cropped out of the current image in FIG. 2D.

Step S308: Feed the current ROI image to the PP-MobileSeg model to output a current ROI label map. The current ROI label map is shown in FIG. 3E based on the current ROI image in FIG. 3D.

Step S310: Count a number P1 of pixel positions, each of which is marked with different classes in the reference and the current ROI label maps. Then, divide P1 by a total number P2 (=H1*W1) of pixels to obtain R=P1/P2. Here, the sizes of the reference image and the current image are equal to H0*W0 while the sizes of the reference ROI image, the current ROI image, the reference ROI label map and the current ROI label map are equal to H1*W1, where H1<H0 and W1<W0.

The steps S212~S214 in FIGS. 2-3A, 3G, 4B, 5B and 6B are similar, and thus their descriptions are omitted herein.

FIGS. 3F-3G is a flow chart showing a method of scene change detection in the security surveillance system 100 according to an alternative embodiment of this invention. Hereinafter, the method of scene change detection of this invention will be described in detail with reference to FIGS. 1 and 3F-3G.

Step S360: Provide a reference image containing the closed front door of the house by the image capture module 110.

Step S362: Feed the reference image to the PP-MobileSeg model to output a reference label map. For example, FIG. 2C shows an exemplary reference label map corresponding to the reference image in FIG. 2B.

Step S364: Select the front door as a ROI in the reference label map, and crop the ROI out of the reference label map to obtain a reference ROI label map. For example, a reference ROI label map is shown in FIG. 3C after the ROI 390 is selected and cropped out of the reference label map in FIG. 2C.

Step S365: Capture a current image containing the front door by the image capture module 110 and store the current image in the storage device 150.

Step S366: Feed the current image to the PP-MobileSeg model to output a current label map. For example, FIG. 2E shows an exemplary current label map corresponding to the current image in FIG. 2D.

Step S368: Select the front door as a ROI in the reference label map, and crop the ROI out of the reference label map to obtain a reference ROI label map. For example, a current ROI label map is shown in FIG. 3E after the ROI 390 is selected and cropped out of the current label map in FIG. 2E.

In comparison with the embodiment of FIGS. 3F-3G, the embodiment in FIG. 3A has less computational load for the PP-MobileSeg model and is more efficient since the sizes (W1*H1) of the reference and the current ROI images are less than those (W0*H0) of the reference and the current images.

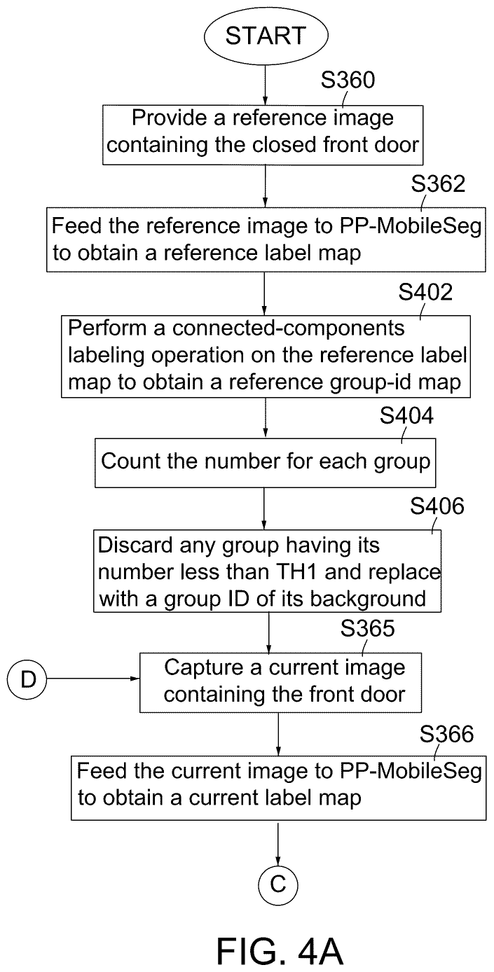

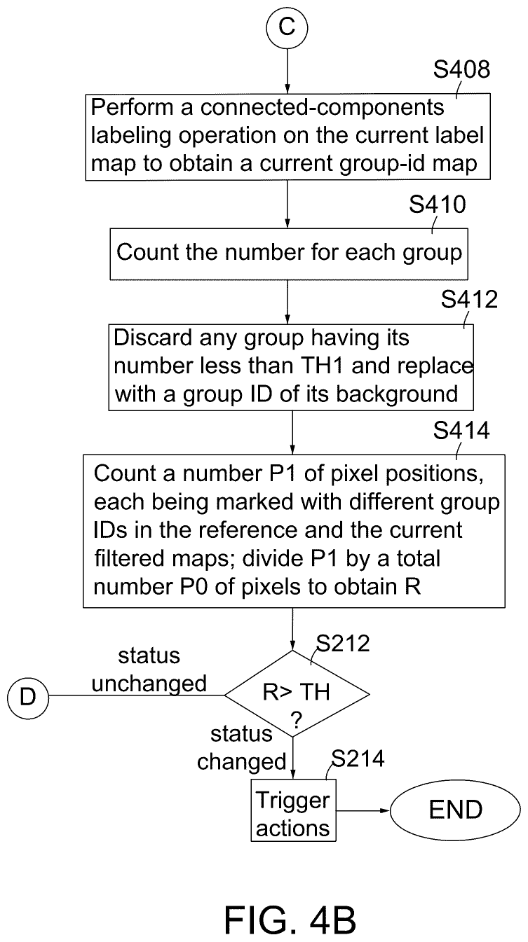

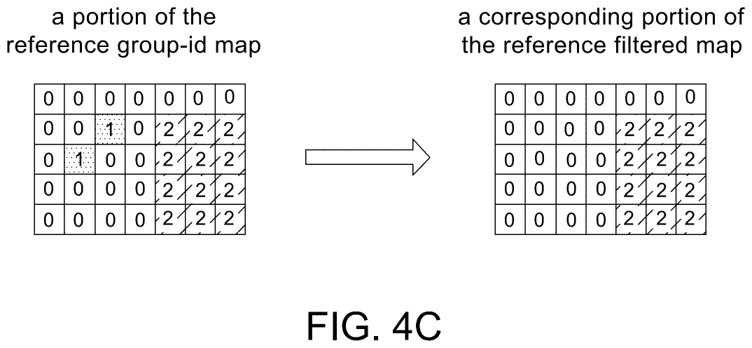

FIGS. 4A-4B depict a flow chart showing a method of scene change detection in the security surveillance system 100 according to an alternative embodiment of this invention. FIG. 4C shows an example of a portion of the reference relabel map and a corresponding portion of a reference filtered map. Hereinafter, the method of scene change detection of this invention will be described in detail with reference to FIGS. 1 and 4A-4C.

In this embodiment, a “connected-components labeling” operation is performed to scan a label map, group its pixels into components based on pixel connectivity and assign a unique group ID number to each group, i.e. all pixels in a connected component share the same group ID and are in some way connected with each other. Once all groups have been determined, each pixel is labeled with a corresponding group id according to the component it was assigned to.

Step S402: Perform a connected-components labeling operation on the reference label map from the step S362 to obtain a reference group-id map. As shown on the left side of FIG. 4C, there are three groups in the portion of the reference group-id map.

Step S404: Count the number of pixels for each group/component in the reference group-id map. On the left side of FIG. 4C, there are 21 pixels for group 0, there are 2 pixels for group 1 (dotted area) and there are 12 pixels for group 2 (slashed area).

Step S406: Discard any group/component having the number P3 of pixels less than TH1 (P3<TH1) in the reference group-id map, and replace the group ID of the discarded group with a group ID of its background to obtain a reference filtered map. The goal of this step is to eliminate noise in the reference relabel map. For example, TH1 is set to 4; for the example of the left side of FIG. 4C, group 1 having two pixels (P3=2) would be discarded because P3<TH1. Then, the ID of the discarded group with two pixels is replaced with a group ID of its background, i.e., 0, as shown on the right side (reference filtered map) of FIG. 4C.

Step S408: Perform the connected-components labeling operation on the current label map from the step S366 to obtain a current group-id map. The operations of steps S408 to S412 are similar to those of steps S402 to S406.

Step S410: Count the number of pixels for each group/component in the current group-id map.

Step S412: Discard any group/component having the number P4 of pixels less than TH1 (P4<TH1) in the current group-id map, and replace the group ID of this discarded group with a group ID of its background to obtain a current filtered map. The goal of this step is to eliminate noise in the current group-id map.

Step S414: Count a number P1 of pixel positions, each of which is marked with different group IDs in the reference and the current filtered maps, and then divide P1 by a total number P0 (=H0*W0) of pixels to obtain R=P1/P0, where the sizes of the reference group-id map, the current group-id map, the reference filtered map and the current filtered map are equal to (H0*W0).

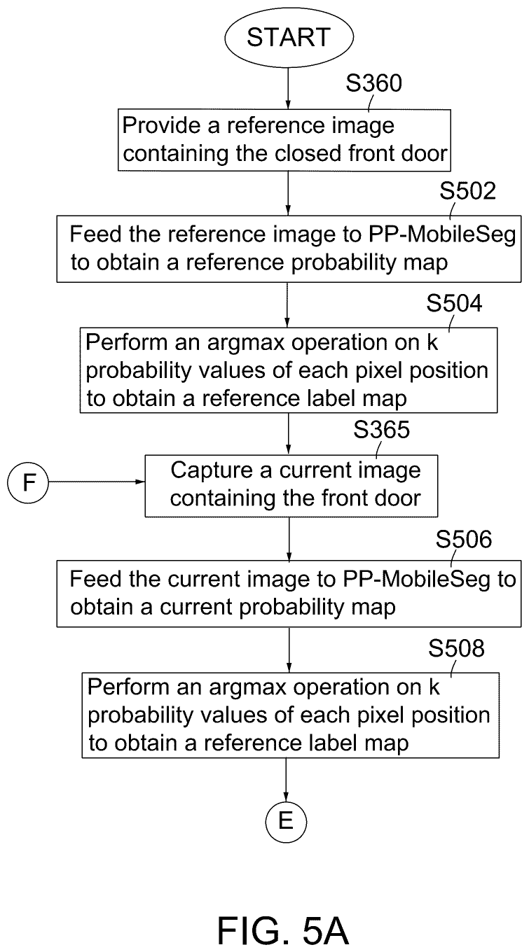

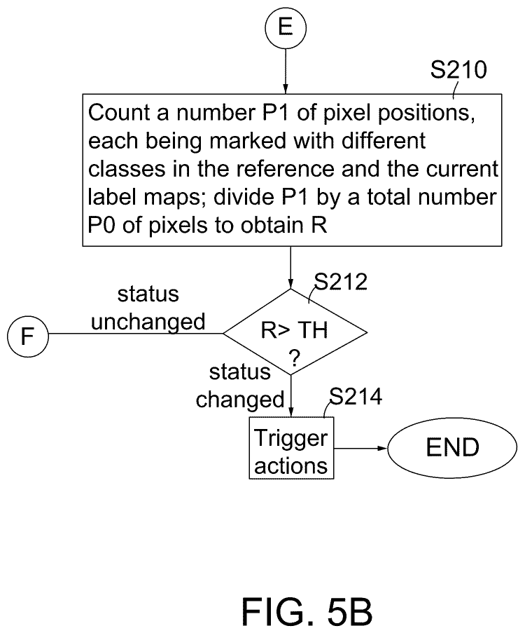

FIGS. 5A-5B is a flow chart showing a method of scene change detection in the security surveillance system 100 according to an alternative embodiment of this invention. Hereinafter, the method of scene change detection of this invention will be described in detail with reference to FIGS. 1 and 5A-5B.

Step S502: Feed the reference image from the step S360 to the PP-MobileSeg model to output a reference probability map including k-channel array, where each channel represents a class, k indicates the number of classes and is determined by a training dataset of the pre-trained model 152. For the PP-MobileSeg model, k=150.

Step S504: Perform an argmax operation on k probability values of each pixel position of the reference probability map to output a reference label map, where k>0. As well known in the art, the argmax function (often written as argmax()) finds the index of the maximum value in a series of values. In this embodiment, the argmax operation is performed on the k probability values at the same pixel position of the k-channel array of the reference probability map to find the index of the maximum probability value. Take a pixel position (0,0) at the upper left corner of the k-channel array for example. The k probability values for the same pixel position (0,0) are fetched from the k-channel array of the reference probability map and then arranged in sequence so that the argmax operation can find the index of the maximum probability value among the series of probability values. Thereafter, according to the index of the maximum probability value, its corresponding class value is written into the pixel position (0,0) of the reference label map. In the same manner, the argmax operation continuously proceeds until all the pixel positions of the reference label map are completed/written.

Step S506: Feed the current image from the step S365 to the PP-MobileSeg model to output a current probability map including k-channel array.

Step S508: Perform the argmax operation on k probability values of each pixel position for the current probability map to output a current label map. The operations of steps S504 and S508 are similar.

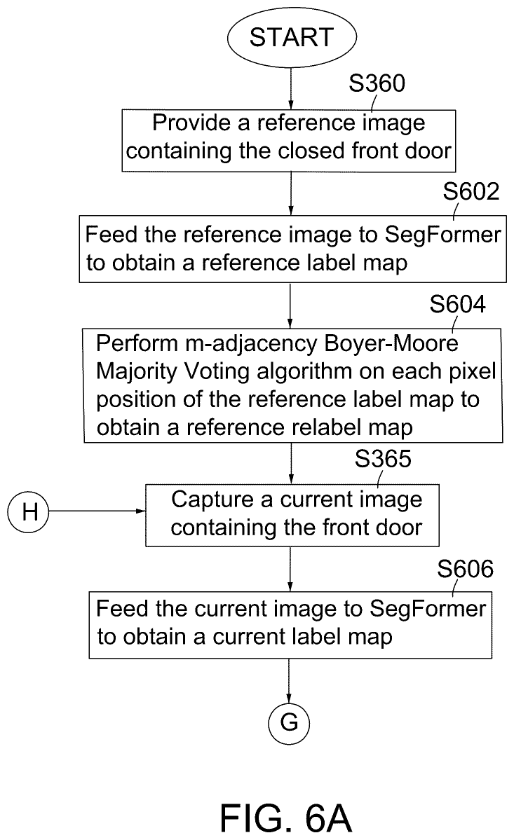

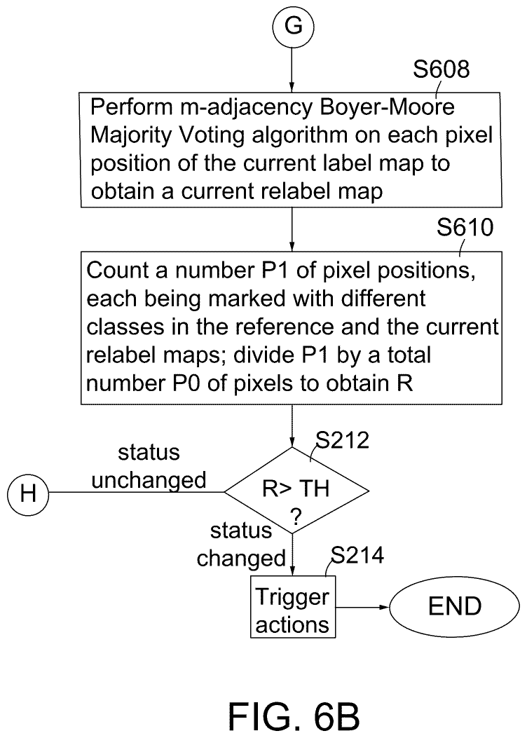

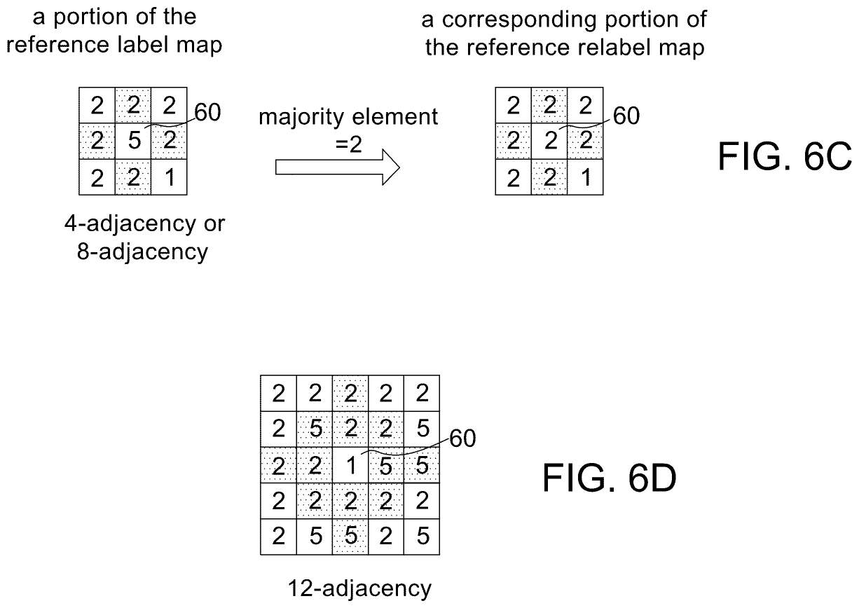

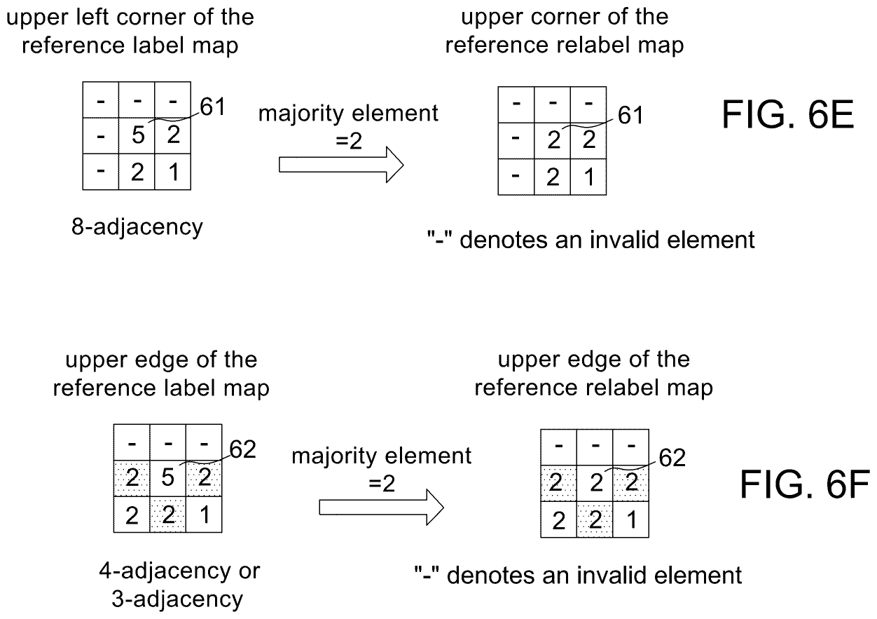

FIGS. 6A-6B depict a flow chart showing a method of scene change detection in the security surveillance system 100 according to an alternative embodiment of this invention. FIGS. 6C-6F show four examples of how to obtain a majority element using m-adjacency Boyer-Moore Majority Voting algorithm, where m>0. Hereinafter, the method of scene change detection of this invention will be described in detail with reference to FIGS. 1 and 6A-6F and with assumption that the pre-trained model 152 is SegFormer model.

Step S602: Feed the reference image from the step S360 to the SegFormer model to output a reference label map.

Step S604: Perform m-adjacency Boyer-Moore Majority Voting algorithm on each pixel position of the reference label map to obtain a reference relabel map. As well known in the art, the term “m-adjacency” refers to a connectivity criterion used in image processing and computer graphics to define m neighboring pixels. For a case of m=8, in a 2D binary image, a pixel is considered 8-adjacent to its eight immediate neighbors: the four pixels directly above, below, left, and right, and the four diagonal pixels. As well known in the art, the Boyer-Moore majority voting algorithm finds the majority element among the given elements using linear time and a constant number of words of memory. Throughout the specification and claims, the term “m-adjacency Boyer-Moore majority voting algorithm” refers to an operation of finding the majority class among m-adjacent pixels of/around a central/selected pixel. Referring to the example in FIG. 6C, if a selected pixel position 60 is not on any one of the four edges of the reference label map, it is determined the majority class is 2 using the 8-adjacency Boyer-Moore majority voting algorithm among its eight valid immediate neighbors (m=8). Finally, the majority class 2 is written into the selected pixel position 60 for the reference relabel map. On the other hand, if m is set to 4, it is determined the majority class is 2 using the 4-adjacency Boyer-Moore majority voting algorithm among its four immediate neighbors in dotted area; then, the majority class 2 is written into the selected pixel position 60 for the reference relabel map. Referring to the example in FIG. 6D, if m is set to 12, it is determined the majority class is 2 using the 12-adjacency Boyer-Moore majority voting algorithm among its twelve valid immediate neighbors in dotted area; then, the majority class 2 is written into the selected pixel position 60 for the reference relabel map. Referring to the example of FIG. 6E, a selected pixel position 61 is at one of four corners, such as the upper-left corner, of the reference label map; if m is set to 8, it is determined the majority class is 2 using the 8-adjacency Boyer-Moore majority voting algorithm among its valid three neighboring pixels (directly below, on the right, and bottom-right) and please note the pixels directly above, on the left, top-left, top-right and bottom-left are invalid and disregarded. Finally, the majority class 2 is written into the selected pixel position 61 for the reference relabel map. Referring to the example of FIG. 6F, a selected pixel position 62 is on one of four edges, such as the upper edge, of the reference label map; if m is set to 4, it is determined the majority class is 2 using the 4-adjacency Boyer-Moore majority voting algorithm among its valid three neighboring pixels in dotted area, and the pixel directly above is invalid and disregarded. Finally, the majority class is 2 is written into the selected pixel position 62 for the reference relabel map. On the other hand, if m is set to 3, it is determined the majority class is 2 using the 3-adjacency Boyer-Moore majority voting algorithm among its three immediate neighbors in dotted area; then, the majority class 2 is written into the selected pixel position 62 for the reference relabel map. In this manner, the reference label map is processed on a pixel-by-pixel basis to obtain the reference relabel map. The goal of this step is to eliminate noise in the reference label map. Different m values are selected according to different design needs and may incur different computation loads.

Step S606: Feed the current image from the step S365 to the SegFormer model to output a current label map.

Step S608: Perform m-adjacency Boyer-Moore Majority Voting algorithm on each pixel position of the current label map to obtain a current relabel map. The operations of the steps S604 and S608 are similar. The goal of this step is to eliminate noise in the current label map.

Step S610: Count a number P1 of pixel positions, each of which is marked with different class values in the reference and the current relabel maps. Then, divide P1 by a total number P0 (=H0*W0) of pixels to obtain R=P1/P0. Here, the sizes of the reference relabel map and the current relabel map are equal to H0*W0.

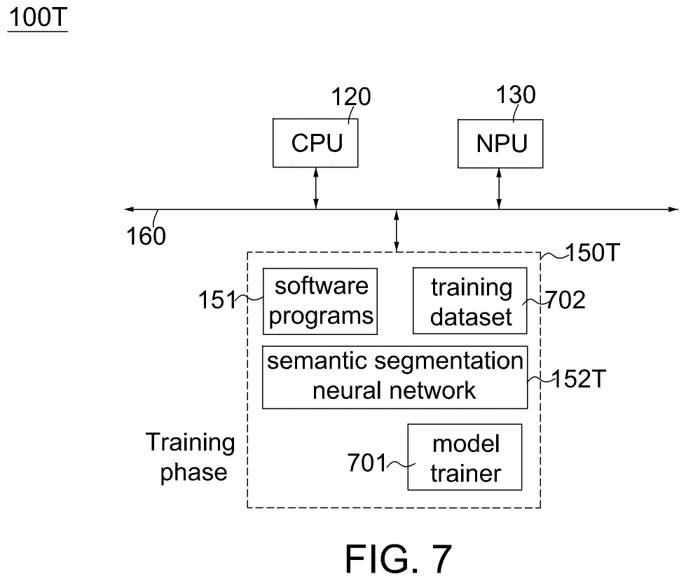

FIG. 7 is a schematic diagram showing a security surveillance system 100T in a training phase according to an embodiment of this invention. Referring to FIG. 7, the security surveillance system 100T (related to the security surveillance system 100 in FIG. 1) in a training phase includes the CPU 120, the NPU130 and a storage device 150T. The CPU 120, the NPU 130 and the storage device 150T may communicate with each other through a system bus 160.

The storage device 150T may store data and instructions/program codes of a model trainer 701 operable to be executed by the CPU 120 and the NPU 130 to cause the security surveillance system 100T to train a SS neural network 152T. The model trainer 701 can train the SS neural network 152T based on a training dataset 702 using various training or learning techniques, such as, back propagation of errors. The SS neural network 152T can be pre-trained by inputting a training image from the training dataset 702 into the SS neural network 152T. Each training image can have, for example, one or more ground-truth SS masks (e.g., label maps and/or probability maps). The data of the training images are constructed artificially by adding varying lighting/shadow conditions to clean object image data while the ground-truth SS masks correspond to class/probabilities information of the clean object image data. For the object image data, a wide range of object image data is collected, such as image data of different objects, different people and different animals in everyday life. Then, the training image can be input into the SS neural network 152T to obtain a resultant SS mask. A loss function can be determined and adjust parameters (e.g., weights) of the SS neural network 152T based on the difference between the resultant SS mask and a corresponding ground-truth SS mask. In some implementations, the SS neural network 152T can be pre-trained using the loss function and the training dataset 702 by back propagating errors from the resultant SS mask as compared to the ground-truth SS mask.

The above embodiments and functional operations can be implemented in digital electronic circuitry, in tangibly-embodied computer software or firmware, in computer hardware, including the structures disclosed in this specification and their structural equivalents, or in combinations of one or more of them. The methods and logic flows described in FIGS. 2A, 3A, 3F-3G, 4A-4B, 5A-5B and 6A-6B can be performed by one or more computers executing one or more computer programs to perform their functions. The methods and logic flows in FIGS. 2A, 3A, 3F-3G, 4A-4B, 5A-5B and 6A-6B, can also be performed by special purpose logic circuitry, e.g., an FPGA (field programmable gate array) or an ASIC (application-specific integrated circuit). Computers suitable for the execution of the one or more computer programs include, by way of example, can be based on general or special purpose processors or both, or any other kind of central processing unit.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A method of scene change detection, applicable to a monitoring system having an image capture module, the method comprising steps of:
capturing a first image and a second image by the image capture module at different timestamps, wherein each of the first and the second image contains a same target;
respectively transforming the first and the second images into a first semantic segmentation mask and a second semantic segmentation mask using a pre-trained semantic segmentation model;
comparing pixel values of a first resultant map and a second resultant map respectively derived from the first and the second semantic segmentation masks on a pixel-by-pixel basis to count a number P1 of pixel positions with different pixel values; and
triggering one or more actions by the monitoring system according to the number P1 and a total number of pixels in each of the first and the second resultant maps.

2. The method according to claim 1, wherein each pixel of the first semantic and the second semantic segmentation masks contains a class value.

3. The method according to claim 2, wherein the step of respectively transforming the first and the second images into the first and the second semantic segmentation masks is based on a region of interest (ROI) using the pre-trained semantic segmentation model, and wherein a total number of pixels in the ROI is less than a total number of pixels in each the first and the second images.

4. The method according to claim 3, further comprising:
after the step of respectively transforming,
respectively selecting the same target as the ROI in the first and the second semantic segmentation masks; and
respectively cropping the ROI out of the first and the second semantic segmentation masks to obtain the first and the second resultant maps;
wherein a total number of pixels in each of the first and the second resultant maps is less than a total number of pixels in each of the first and the second semantic segmentation masks; and
wherein the pixel values of the first and the second resultant maps are class values corresponding to class labels.

5. The method according to claim 3, wherein the step of respectively transforming comprises:
respectively selecting the same target as the ROI in the first and the second images;
respectively cropping the ROI out of the first and the second images to obtain a first ROI image and a second ROI image; and
respectively transforming the first and the second ROI images into the first and the second resultant maps using the pre-trained semantic segmentation model;
wherein the pixel values of the first and the second resultant maps are class values corresponding to class labels.

6. The method according to claim 2, further comprising:
after the step of respectively transforming and prior to the step of comparing,
respectively performing a connected-components labeling operation on the first and the second semantic segmentation masks to obtain a first group-id map and a second group-id map;
respectively counting a total number of pixels for each of multiple groups in the first and the second group-id maps;
replacing a group ID of a first specified group with a group ID of its background in the first group-id map to obtain the first resultant map; and
replacing a group ID of a second specified group with a group ID of its background in the second group-id map to obtain the second resultant map;
wherein the pixel values of the first and the second resultant maps are group IDs;
wherein the first specified group is selected from the multiple groups in the first group-id map and has the total number of pixels less than a first threshold; and
wherein the second specified group is selected from the multiple groups in the second group-id map and has the total number of pixels less than the first threshold.

7. The method according to claim 2, further comprising:
after the step of respectively transforming and prior to the step of comparing,
respectively performing m-adjacency Boyer-Moore Majority Voting algorithm on each pixel position of the first and the second semantic segmentation masks to obtain the first and the second resultant maps;
wherein the m-adjacency Boyer-Moore majority voting algorithm corresponds to an operation of finding a majority class among m adjacent pixels of a selected pixel; and
wherein the pixel values of the first and the second resultant maps are class values corresponding to class labels.

8. The method according to claim 1, further comprising:
after the step of respectively transforming and prior to the step of comparing,
performing an argmax operation on k probability values of each pixel position of the first semantic segmentation mask to output the first resultant map; and
performing the argmax operation on k probability values of each pixel position of the second semantic segmentation mask to output the second resultant map, where k>0;
wherein each of the first and the second semantic segmentation masks is a probability map including a k-channel array and the k value depends on the pre-trained semantic segmentation model; and
wherein the pixel values of the first and the second resultant maps are class values corresponding to class labels.

9. The scene change detection according to claim 1, wherein the monitoring system is one of a security surveillance system and an environmental monitoring system.

10. The method according to claim 1, wherein the step of triggering comprises:
triggering the one or more actions by the monitoring system when P1/P0 is greater than a second threshold, where P0 denotes a total number of pixels in each of the first and the second resultant maps.

11. The method according to claim 1, wherein the pre-trained semantic segmentation model is based on one of PP-MobileSeg and SegFormer.
